(19) United States
(12) Patent Application Publication
(10) Pub. No.: US 2004/0049449 A1
(43) Pub. Date: Mar. 11, 2004

(54) Electronic trading system and method for accounts receivables and payables

(76) Inventor: Rolando H. Martinelli, Panama (PA)

Correspondence Address: SHAHAN ISLAM, ESQ., KMZ ROSENMAN, 575 Madison Avenue, New York, NY, 10022-2585, US

(21) Appl. No.: 10/241,603

(22) Filed: Sep. 11, 2002

(51) Int. Cl. G06F 17/60

(52) U.S. Cl. 705/38

(57) ABSTRACT

The electronic trading system and method for accounts receivables and payables is a web-based blind trading system where member debtors and creditors are able to anonymously transact their Account Payables (A/Ps) and Account Receivables (A/Rs) at the lowest possible effective interest rates. The System provides an alternative arena for financing A/Rs and A/Ps as well as other non traditional asset-based financing alternatives in an efficient and cost effective manner that are not offered in the marketplace today. Although intended primarily for Merchants and Corporations, banks, Financial Institutions, small and medium sized businesses, individual investors and trading partners are an important part of the concept.

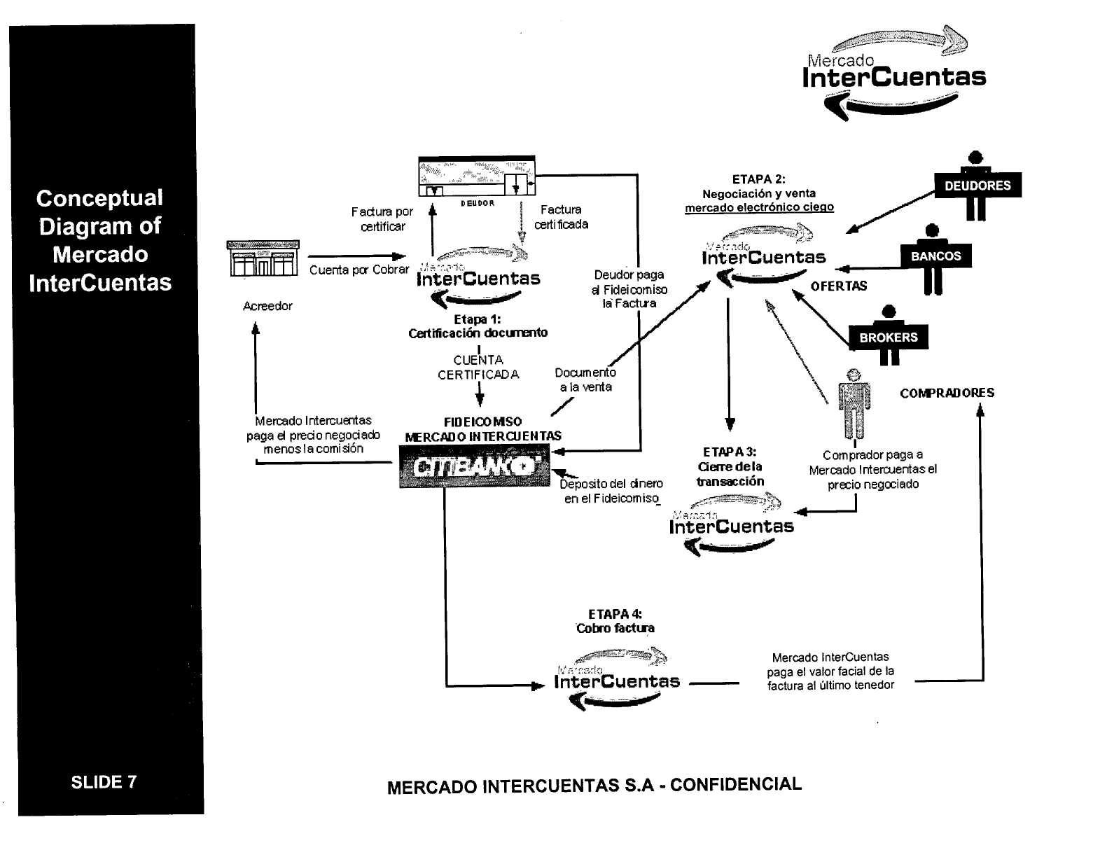

### BACKGROUND OF THE INVENTION

1. Field of the Invention

The present invention is relates to an electronic trading system for accounts receivables and payables and more particularly to a web-based blind trading system where member debtors and creditors may anonymously transact their Account Payables (A/Ps) and Account Receivables (A/Rs).

2. Description of Related Art

Factoring or Factor Financing is the activity by which investors buy commercial invoices or A/Rs from the original seller or from the current holder. Essentially, Factoring is a discount operation where buyers discount up-front fees and interest rate plus contingencies. Therefore, sellers receive a percentage of the face value of the account at the time of sale, and may receive an additional payment if the debtor pays the account promptly. Factor Financing is done with or without recourse to the seller of the account; in the former case, buyers often require additional guarantees from sellers. Factoring is a traditional financing vehicle in several countries. It is, for example, common in the garment industry in the U.S.

A highly manual and somewhat cumbersome documentation process characterizes the industry. This has lead successful participants to concentrate on large invoices and/or easy to collect well-known accounts. Since charges can often be high and sellers do not bring to buyers longer term invoices unless it is absolutely necessary. Therefore there is high concentration in the Factoring Industry, despite the highly competitive local banking industry and the lucrative opportunities. Their success seems largely due to their ability to quickly process client's requests and to operate in the larger per invoice niche of the market.

Factoring is largely limited to minimum size transactions and limited number of potential sellers. The total size of the factoring market will be largely expanded by increasing market visibility while affording anonymous bidding, lower minimum invoice size requirements and the reduction of transaction costs improve because of the electronic trading system for accounts receivables and payables as disclosed herein.

Two important market trends are relevant to the future success of the present system: (1) the explosive adoption of auction-based business-to-business (B2B) models; and (2) the growing utilization of “off balance sheet” financing by companies in the form of receivables discount, securitization of assets and similar asset-based schemes.

With the geometric growth of auction-based B2B models, more businesses become rapidly familiar with Web-based technologies. Installed capacity in the form of hardware and software is more likely to be in place in many businesses in order to take advantage of some form of B2B opportunity. Both considerations reduce the possible investment and attitude barriers of potential members of the present system since they will be already familiar and technologically able to grasp this business model. Furthermore, since potential system members may already participate or have been invited to participate in one or many of the Web based models, the operating communications and connections costs for adding the system should be marginal.

Deregulation of certain financial markets coupled with the ever-growing use of communications technology has made businesses less dependent on traditional financing institutions. Nowadays, companies seek more financing alternatives through non-intermediary means. These non-intermediary means usually present size handicaps since small companies with small A/R amounts do not interest the major Factoring markets for business. The present system will obviate this paradigm since the web-based system will open the scope for most small businesses that wish to become members. Among the most important is the use of asset-backed schemes, including A/Rs financing.

The Internet has not had a direct impact on the A/R financing industry since it has only served to support factoring companies in their standard way of doing business. It has been used mainly as an information and data-capturing tool. The present system should change the A/R financing industry by using the Internet as a transaction and risk pricing facilitator.

Using the present system, small and medium size business owners will be able to sell their A/Rs online from a computer terminal in their own office or through a trader. The way in which the business process has been set up allows members to introduce A/Rs into the InterCuentas system and then trade them online. This efficiency is achieved by the use of a member's contract by which all aspiring members agree to follow a number of rules and regulations that allow for freely tradable A/R documents.

The Internet allows the present system to operate a blind trading system by which risks are correctly measured in accordance to the debtor's financial and commercial risk, and not incorrectly measured in accordance with the creditor's (A/R holder) financial clout. This “new way” of pricing A/R risk will immediately lower the financing costs of AIR holders creating three phenomena: 1) the exodus of factoring company clients to the present system to seek lower costs of financing; 2) factoring companies becoming brokers offering for sale well known A/Rs pocketing a large spread in a couple of days and saving on collection costs; and 3) creating a viable alternative for all those A/R holders that remain on the sidelines because of the high cost of financing provided by factoring companies.

### SUMMARY OF THE INVENTION

The present Electronic Trading System For Accounts Receivables And Payables provides a solution for the difficult short term A/R credit market. It is an online marketplace which allows its members to anonymously buy, sell, triangulate, and short sell A/Rs, or any kind of commercial documents electronically and cost efficiently. Examples of commercial documents are A/Rs such as invoices, and statement of accounts, purchase orders, contracts, mortgages, loans, etc. Through the use of Internet technologies, the present system allows members to access its secure website through any web-enabled PC, 24 hours a day, 7 days a week.

The present system also provides liquidity to small, medium, and large corporations, by providing them access to a liquid e-Marketplace which allows them to sell, finance or triangulate A/Rs and other asset-based financing alternatives. To achieve this mission, it is imperative that the present system maintains the anonymity of all buyers and sellers in order to allow for competition to correctly and efficiently price credit risks. This provides the opportunity to debtors to buy their own A/Ps at a discount without the supplier knowing the debtor purchased it.

### DETAILED DESCRIPTION OF THE PREFERRED EMBODIMENT

The Electronic Trading System And Method For Accounts Receivables And Payables is described in detail herein and with reference to the sole drawing.

The System's Platform is divided into four Modules which encompass all the functionalities available for use by a member. These are the Trading Module, the Depository Module, the Clearing Module, and the Information/Service Module.

The Trading Module:

The Trading Module addresses all of the trading functions which go along with the buying and selling of A/Rs. The basic purpose of this module is to match the buyer and seller that agree upon a discount (price) to close a transaction that effectively exchanges cash for A/R or A/P for A/R. All of the features and functionalities in this module are geared towards simplifying the matching of bids and offers.

The Depository Module:

The Depository Module is the system of features and functionalities that insures that all of the A/Rs posted for sale through the Trading Module have been deposited into the System. It also notifies members whether or not the A/R has been certified by the debtor. The document is scanned so that debtors are able to see a digital image of the A/R on their screens prior to certifying it. The physical document resides in the custody of the present system or in the custody of a third party hired to perform the task. Furthermore, the Depository Module also insures that once the debtor pays the final owner of the A/R, the physical document will reach the debtor for accounting purposes.

The Clearing Module:

Once an A/R is deposited and a bid/ask match has been established, the functionalities of the Clearing Module start working. Its main task is to perform what is known as Delivery versus Payment (DVP), which basically consists of exchanging the transacted assets (be it cash for A/R or A/P for A/R) in a timely manner, insuring that each party receives what they transacted for. This process involves checking that all the parties have the assets in their System accounts before “consummating” the transaction. If the buyer does not have the cash or the A/P to trade for the seller's A/R, then the buyer will not be able to place a bid and the transaction is not performed, protecting the interests of all parties involved. The System guarantees that sellers own the A/Rs they are offering for sale and that buyers have cash available to buy the A/Rs, so no bids will be posted from buyers who do not have the resources to honor their commitment.

The Information Module:

The Information Module provides financial and commercial information on all issuers that have deposited A/Rs in the present system. It also provides investors with payment records of member debtors in order to help investors and sellers establish proper pricing for the A/Rs they transact. In addition to debtor information, the System will provide its members with instant A/R and A/P inventory balances, cash balances, trading log and a monthly statement of account that summarizes all these services.

Types of membership:

In the present system, members must affiliate and accept the System's uniform terms and conditions before they can buy and sell documents. There are in the preferred embodiment, 5 types of memberships:

Debtor (pays the credit),

Buyer/Seller (buys and/or sells credits)

Intermediary (buys and sells credits on his customers accounts)

Information gatherer (does not buy nor sell but has access to statistical info)

International player (can do business globally thru the different InterCuentas in other countries)

Buyer/Sellers are suppliers, brokers, financial institutions, banks, investment funds, individuals; debtors who want to buy and sell either their credits or others. A member can have more than one membership type.

The present Electronic Trading System And Method For Accounts Receivables And Payables involves a number of steps. A Seller member brings all original documents that establish his ownership of such credits and places the terms of his selling offer. The System digitizes all documents and captures all general information and selling offer. The Debtor is electronically notified of a document for certification and payment cession and can either certify it as a legitimate claim against it or not. The Debtor membership obligates Debtors who certify documents to not make deductions from face value and to agree to pay it and cede payment to the System. When will the document be paid is not certain, as the only risk remaining for investors is the debtor's commercial risk. Documentary risk may be reduced or eliminated through an insurance policy. If the Debtor certifies the debt as legitimate, it will have the first option to buy it at a discount before it is available for trade to other investors. If Debtor does not certify it, it is required to input an explanation to the Seller and the document is not placed for sale and is returned to Seller. Only certified documents are available for trade. The Seller will never know who bought its document, as it is a blind system. If the Debtor certifies the document but does not buy it, the document is offered for sale on the trading system to other investors. Depending on the type of selling offer chosen by the Seller, investors bid for it under Seller's conditions. When the buyer accepts the Seller's offer or vice versa, or the time limit runs out and a Buyer offered more than the minimum accepted by the Seller, the transaction closes and payment is electronically handled via Automated Clearing House transactions by, preferably, Citibank, N.A., with whom the applicant has an alliance to perform trust, custody and liquidation duties. In the preferred System, members are required to open bank accounts for the exclusive use of trading in the present System. When the System collects from the Debtor, it pays the last holder of the document via ACH.

In addition to the methodology by which the present System functions, as delineated above, the following additional features characteristics of the present System must be pointed out.

First the System provides an Online marketplace for any kind of commercial credit and is a blind online trading system used to trade commercial documents such as A/Rs sold by invoice originators or intermediaries. There are several different types of electronic marketplaces, but most trade either on securities or auction of objects, but not on different commercial documents or contracts. Examples of commercial documents include, but are not limited to A/Rs such as invoices and statement of accounts, purchase orders, contracts, mortgages, loans, etc.

Second, the system provides, as explained, an Online blind marketplace in which investor's only know who the Debtor is, not who the Seller is. Investors know general information on the document such as face value, estimated payment date and the selling terms. Investors bid for the document according to their perception of the Debtor's risk and payment history. Indeed, many different types of selling offers, including the following may be chosen by sellers in the same platform:

1. Fixed annual yield auction without acceptance of counter offers: seller establishes the desired fixed annual yield he wants the investor to earn on him and does not accept counter offers. The present value of the document is calculated daily based on the estimated payment date. The system does not allow buyers to offer an interest rate different from that asked by the seller. Seller defines for how long his offer to sale is available. If the time on the selling offer limit expires, the seller has the option to extend it or retire the document from trading. Seller can modify his offer at any time.

2. Fixed annual yield auction with acceptance of counter offers: seller establishes the desired fixed annual yield he wants the investor to earn on him and accepts counter offers. The present value of the document is calculated daily based on the estimated payment date. The system allows buyers to offer an interest rate lower than that asked by the seller. Seller and buyers can make modify their respective offers until the transaction closes. If the time limit on the selling offer expires, the seller has the option to extend it or retire the document from trading. Seller can modify his offer at any time.

3. Fixed price auction without daily update and without acceptance of counter offers: seller establishes the desired fixed price he wants the investor to pay him and does not accept counter offers. The present value of the document is fixed and the annual yield increases daily as maturity nears. The system does not allow buyers to offer a price different from that asked by the seller. Seller defines for how long his offer to sale is available. If the time limit expires, the seller has the option to extend it or retire the document from trading. Seller can modify his offer at any time.

4. Fixed price auction without daily update and with acceptance of counter offers: seller establishes the desired fixed price he wants the investor to pay him and does not accept counter offers. The present value of the document is fixed and the annual yield increases daily as maturity nears. The system allows buyers to offer a price lower than that asked by the seller. Seller defines for how long his offer to sale is available. If the time limit expires, the seller has the option to extend it or retire the document from trading. Seller can modify his offer at any time.

5. Fixed price auction with daily update and without acceptance of counter offers: seller establishes the desired fixed price he wants the investor to pay him and does not accept counter offers. The price varies daily according to a pre-established daily increment and the annual yield may or may not increase daily as maturity nears. The system does not allow buyers to offer a price different from that asked by the seller daily. Seller defines for how long his offer to sale is available. If the time limit expires, the seller has the option to extend it or retire the document from trading. Seller can modify his offer at any time.

6. Fixed price auction with daily update and with acceptance of counter offers: seller establishes the desired fixed price he wants the investor to pay him and accepts counter offers. The price varies daily according to a pre-established daily increment and the annual yield may or may not increase daily as maturity nears. The system allows buyers to offer a price lower than that asked by the seller daily. Seller defines for how long his offer to sale is available. If the time limit expires, the seller has the option to extend it or retire the document from trading. Seller can modify his offer at any time.

7. Blind time-limited minimum price auction. Seller establishes the minimum price he wants to be paid prior to the System's commissions. The system does not allow buyers to make bids lower than that minimum price. Investors do not know the highest bid and bids are accepted until a pre-defined time limit imposed by the System.

8. Visible time-limited minimum price auction. Seller establishes the minimum price he wants to be paid prior to the System's commissions. The system does not allow buyers to make bids lower than that minimum price. Investors can see all bids being made, but do not know who made them and bids are accepted until a pre-defined time limit imposed by the System. The highest bidder wins.

9. Blind time-limited maximum annual yield auction. Seller establishes the maximum annual yield he wants the investor to earn. Seller must pay the System for its fees in addition to this yield to the investor. The system does not allow buyers to make bids higher than that maximum yield. Investors do not know the highest bid and bids are accepted until a pre-defined time limit imposed by the System.

10. Visible time-limited maximum yield auction. Seller establishes the maximum annual yield he wants the investor to earn. Seller must pay the System for its fees in addition to this yield to the investor. The system does not allow buyers to make bids higher than that maximum yield. Investors can see all bids being made, but do not know who made them and bids are accepted until a pre-defined time limit imposed by the System. The highest bidder wins.

The system allows investors to see all documents in it. It could even be certified documents bought by an investor and not offered for resale. That is, another investor could make a bid on a non-offered for sale certified document in the system. All offers to sale have a single type of selling offer. Buyers can only place bids according to the selling offer chosen by the seller.

The System also allows buyers to make in depth searches for documents with specific criteria. Examples of different search variables which can be used are: i) Debtor; ii) annual yield offered; iii) minimum price requested; iv) type of selling offer; v) remaining time on offer to sale; vi) estimated payment date; vii) remaining time for payment; viii) document face value; ix) certified document status (offered for sale or not offered for sale). Buyers can make advanced searches using multiple variables.

The System allows Sellers to modify their offers at any time as long as their offers are not time-limited (see selling offer types 7, 8, 9 and 10 above). Sellers can modify their offer terms and types at any time directly through the web site. They do not need cooperation from InterCuentas. Only when offers are time-limited sellers cannot modify their offers. This is so, because these time limits are imposed by the System and not by the seller.

The System provides no fund retention or recourse against the seller. Since the Debtor has formally accepted that the documents are valid and that it will pay for them, there is no need to have fund retention or recourse against the seller. All buyers must take into consideration this when making bids. The System reserves the right to request temporary recourse from a new seller. Brokers and intermediaries in general, can request fund retention and recourse against their clients but cannot place such restrictions on their offers to sale in the System.

The System also guarantees seller owns credits and that investor has cash availability. Since the System is blind, it guarantees that a seller is the rightful owner and beneficiary of an original document that it has it in physical custody in a sub-account under a System trust and that has been previously certified by its Debtor. In addition, the System requires investors to open an exclusive trading account to participate in the trading system. The System guarantees to sellers that offers made by investors are legitimate and that have the necessary cash availability to close the transaction. The rules and regulations of the System forbid investors to move or withdraw money from such accounts without the prior written permission of the System.

When a transaction closes, the System sends ACH transactions preferably to Citibank, N.A. to debit investor's account and credit the System and simultaneously as soon as cash is available in System's account, debit the System for transacted price less corresponding fees and credit Seller account with the balance. The System is in the middle to ensure anonymity of Seller and investor. If both seller and investor have an account in Citibank, N.A. settlement occurs in the same day, if any of them has a bank account in other banks, settlement may take up to four days.

In the present System, all cessions of payment are in favor of a Mercado InterCuentas trust. The owners of such credits are registered as sub-account beneficiaries in that trust. All retrading that happens with a document after the initial sale closes are electronically registered in the System to update the records of the new beneficiary. At collection time, the System credits the face value less corresponding fees to the last beneficiary registered in the trust. All transactions automatically update the trust records. These records have legal value in establishing who the beneficiary is.

The trust and cession of payment to the present System allows for multiple retrading without notifying Debtor of current beneficiary. This feature allows trading of a document multiple times without having to notify debtor who the current beneficiary is. That is, Debtor knows that it will only need to pay to the System at the end, and it is the System's responsibility to forward payment to the rightful beneficiary. If seller withdraws the document from the System after a Debtor certified it and cede payment to the System, a reversal of the cession of payment is done to give back to owner the right to collect direct from Debtor.

The System also simplifies registration of legal ownership, as it intermediates on the record keeping allowing for much flexible retrading of documents without having to notify owners. In many countries there is a centralized Public Registry that stores all legalized contracts in the country. So that, for example, a mortgage contract negotiated with a bank, is registered there to formalize the obligation between the parties. By providing this intermediation service, a mortgage customer could switch banks easily without having to incur in so many legal expenses and time to deregister the first bank and register the new lending bank. Under InterCuentas, it would be as simple as changing the records of the beneficiary to reflect the new bank while the new bank pays the prior beneficiary. Under the present System, all such paper work is done only once, while collection is handled by the new bank. Again, everyone can see credit information on the Debtor but the new bank does not know who is the previous mortgage bank. All further cessions are handled via the System as simple changes of ownership of such contracts. This drastically speeds up the process while allowing for much lower legal fees and barriers to exit, thus motivating competition.

In the present System, since it is blind, debtors can buy their own A/Ps at a discount without seller knowing he bought it. Debtors cannot make counter offers at the certification stage. They can only accept or reject the seller's offer. If the debtor wants to make a counteroffer, he will need to reject this initial offer and bid for it in the trading system competing with other investors. If the debtor buys the document, it has the option to retire the original documents from the trust or leave it for retrading. This is an opportunity for the debtor as it will be able to anonymously buy at a discount his own A/Ps making much higher yields than a time deposit of equal maturity.

The present System also allows investors to make bids on certified documents not offered for sale. It may happen that an investor receives a good deal on a document and is keeping it in the system until collection (this is known as being inactive). It can also receive anonymous bids for such document, thus increasing the liquidity of the market. A Beneficiary can turn the status back to active for sale at any time or accept any offer made to him and close the transaction or simply request that no bids are allows and receive no bids on such account.

The System also permits investors to make as many bids are their cash availability allows. That is, if an investor has cash availability of $100,000 he can make as many bids as he wants as long as no single bid is larger than $100,000. Let us say he has made three bids for three different documents. One for $80,000, another for $40,000 and the last one for $25,000. If the first bid wins that document his cash availability drops to $20,000 and his other two bids are automatically eliminated from the system as his cash availability is now lower than the remaining two bids. If on the other hand, the bid of $40,000 wins, only the bid for $80,000 is automatically eliminated from the system, as the remaining cash balance of $60,000 covers the other bid of $25,000.

The System also allows sellers to fraction a document. For example, a statement of account can be fractioned in the invoices it sums up. So a single document can now be sold separately by the pieces that make it up. This feature allows investors to better diversify their risks and allows sellers to reach a wider group of investors who may not have been able to bid for a larger amount. The System acould also offer fractioning of single large invoices, but would require to collect additional fees as the possibility exists that if debtor does not pay, legal ownership of the document must remain under the System as no single beneficiary would be entitled to that single document. That is, the Sytem would need to initiate a legal process with the pre-approved authorization of beneficiaries to collect and pay beneficiaries monies collected if any.

The present System is a global trading platform that could facilitate international business as web and can be duplicated in other countries. The business model and internal rules and regulations will be the same in all countries, unless local laws prohibit part of them. This allows sellers and investors in other countries to trade with counter parties in other countries. For example, a manufacturer in Brazil selling to a U.S. company, could trade his certified A/Rs in InterCuentas USA, with original documents physically stored in custody and in a trust in Citibank, N.A. Brazil and have funds transferred to Brazil via Citibank, N.A.

These features allow for the facilitation of international commerce and diversification of risk. The main benefits are: i) investors will be able to invest in documents owed by debtors in other countries; ii) sellers will more easily collect on exports to foreign companies; iii) international companies will more easily handle treasury and cash management functions, as an executive in a foreign country could manage the portfolio of A/Rs globally thru the System.

The System would allow private companies to participate in the marketplace without disclosing critical financial information and without SEC approval since A/Rs are not securities. In addition, since the risk is the debtor's risk, small and medium sized private companies can participate without having to disclose financial information, which would be irrelevant in this marketplace. Debtors would need to supply minimal financial information and the System will make public the payment history of all debtors so that investors can better estimate the payment date and corresponding required annual yields.

Sellers will not be required to: i) disclose audited financial statements (unless is a public company); ii) get prior approval from a governmental entity such as the SEC, or banking supervisory board; iii) be in business for any amount of time or have minimum sales levels. New companies with certified A/Rs can do business in InterCuentas. InterCuentas reserves the right to a temporary recourse against any new seller. Citibank, N.A. reserves the right to forbid the establishment of a sub-account to any potential member company or individual who appears in the blacklist of the U.S. Department of State as prohibited to do business with.

InterCuentas has an insurance policy that covers all documentary risks. That is, if a mistake is made on the handling of the documentation that prohibits collection from the Debtor, the investor is paid from the insurance. On the other hand, if the investor invested in a company that never paid for reasons other than documentary, for example that went bankrupt he loses his money. The insurance policy covers the following types of risk:

(a) Non existence of seller or debtor

(b) Invalid documents

(c) Documents ceded by unauthorized persons working for the Debtor

(d) Documents signed by unauthorized people

(e) Faulty cessions of payment and certification by Debtor

(f) Illegitimate documents solicited by the beneficiary to obtain the cession of payment approval from Debtor

(g) Account previously ceded to other person

(h) Incomplete documentation

(i) Fraud committed by InterCuentas or any of its employees

Investors only need to take into consideration the commercial risk of the debtor whenever considering placing bids.

The System would maintain track of all payments made by Debtors in the system. This information is very valuable to sellers and investors in estimating their desired annual yields. The System provides many useful real time and historic reports that help complement financial statements from Debtors. For example, with all financial scandals of illegal accounting practices in large US corporations, the System is a very desirable source of information on the daily activities of companies. For example, a bank could track the payment history of a customer and see how his days payables are at any moment and not only when the debtor issues audited financial statements that may be incorrect. This information is more representative of the financial condition of a company as it involves its operations and its relationship with its suppliers day by day. This is a semi-public way for financial institutions to seek interesting target customers in specific industries as well.

Finally, it should be noted that while the above description has referred extensively to a “System,” the System and portions thereof can at times be operated and administered by persons—such as Mercado Intercuentas personnel.

While the preferred embodiment of the System and Method herein have been depicted in detail, modifications and adaptations may be made thereto, without departing from the spirit and scope of the invention as delineated in the following claim(s):

What is claimed is:

1. A method for trading accounts receivables and payables in an electronic system, said method comprising the steps of:
permitting a seller member to bring an establishment of ownership of credits and placing terms of a selling offer;
capturing the establishment of ownership and terms of the selling offer;
electronically notifying a Debtor the establishment of ownership for certification and payment cession, wherein said Debtor can either certify it as a legitimate claim against him or not;
wherein Debtor's certification obligating the Debtor to not make deductions from face value and to agree to pay it and cede payment to the System and provides the Debtor the first option to buy it at a discount before it is available for trade to other investors;
wherein if Debtor does not certify it, he is required to input an explanation to the Seller and the establishment of ownership is not placed for sale and is returned to Seller;
recognizing the acceptance by buyer of seller's offer if the terms are met;
closing the transaction; and
paying the last holder of the establishment of ownership when the System collects from the Debtor.
